(19) United States
(12) Patent Application Publication
(10) Pub. No.: US 2024/0413564 A1
(43) Pub. Date: Dec. 12, 2024

(54) CONNECTOR AND CONNECTOR ASSEMBLY

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Shinji NOZAKI, Mie (JP); Daisuke SAITO, Mie (JP)

(21) Appl. No.: 18/701,549

(22) PCT Filed: Oct. 12, 2022
(86) PCT No.: PCT/JP2022/038016

§ 371 Date: Apr. 15, 2024

(30) Foreign Application Priority Data
Oct. 27, 2021 (JP) 2021-175307

(51) Int. Cl. H01R 13/46; H01R 13/627

(52) U.S. Cl. CPC H01R 13/465; H01R 13/6271

(57) ABSTRACT

A connector to be connected to a mating connector includes a terminal, a housing for accommodating the terminal and a retainer to be movably assembled with the housing. The housing includes a resiliently deformable locking lance for locking the terminal. The retainer includes a restricting portion 62 for restricting resilient deformation of the locking lance by entering a resilient deformation space 43, into which the locking lance is resiliently deformed. The retainer is movable between a retracted position where the restricting portion 62 is retracted from the resilient deformation space 43 and a locking position where the restricting portion 62 is located in the resilient deformation space 43 with the terminal locked by the locking lance. The retainer further moves between the locking position and a completion position indicating the completion of connection of the housing and the mating connector as the mating connector and the housing are connected.

### TECHNICAL FIELD

The present disclosure relates to a connector and a connector assembly.

### BACKGROUND

Conventionally, a connector is known which can detect whether or not connection to a mating connector has been properly completed (Japanese Patent Laid-Open Publication No. 2020-072013). This connector includes a connection assurance component. The connection assurance component is assembled with the connector movably between a temporary locking position and a complete locking position. The connection assurance component is held at the temporary locking position in a state where the mating connector and the connector are not connected, and the connection assurance component is movable to the complete locking position with the mating connector and the connector connected. In this way, the completion of the connection of the mating connector and the connector can be confirmed if the connection assurance component can move from the temporary locking position to the complete locking position.

### PRIOR ART DOCUMENT

### Patent Document

Patent Document 1: JP 2020-072013 A

### SUMMARY OF THE INVENTION

### Problems to be Solved

According to the above configuration, the connection assurance component is moved from the temporary locking position to the complete locking position after the mating connector and the connector are connected. Thus, the efficiency of a connector assembly operation may be reduced.

The present disclosure was completed on the basis of the above situation and aims to provide a technique for improving the efficiency of a connector assembly operation.

### Means to Solve the Problem

The present disclosure is directed to a connector to be connected to a mating connector, the connector being provided with a terminal, a housing for accommodating the terminal and a retainer to be movably assembled with the housing, the housing including a resiliently deformable locking lance for locking the terminal, the retainer including a restricting portion for restricting resilient deformation of the locking lance by entering a resilient deformation space, the locking lance being resiliently deformed into the resilient deformation space, the retainer being movable between a retracted position where the restricting portion is retracted from the resilient deformation space and a locking position where the restricting portion is located in the resilient deformation space with the terminal locked by the locking lance, and the retainer further moving between the locking position and a completion position indicating the completion of connection of the housing and the mating connector as the mating connector and the housing are connected.

### Effect of the Invention

According to the present disclosure, the efficiency of a connector assembly operation can be improved.

### BRIEF DESCRIPTION OF THE DRAWINGS

FIG. 1 is a section showing a female connector and a male connector according to one embodiment.

FIG. 2 is an exploded perspective view showing the male connector.

FIG. 3 is an exploded perspective view showing the female connector.

FIG. 4 is a section along IV-IV in FIG. 5.

FIG. 5 is a plan view showing the female connector in a state where a female retainer is mounted at a retracted position.

FIG. 6 is a perspective view showing the female connector in the state where the female retainer is mounted at the retracted position.

FIG. 7 is a side view showing the female connector in the state where the female retainer is mounted at the retracted position.

FIG. 8 is a perspective view showing the female connector in a state where the female retainer is mounted at a locking position.

FIG. 9 is a plan view showing the female connector in the state where the female retainer is mounted at the locking position.

FIG. 10 is a side view showing the female connector in the state where the female retainer is mounted at the locking position.

FIG. 11 is a section along XI-XI in FIG. 9.

FIG. 12 is a section along XII-XII in FIG. 9.

FIG. 13 is a section along XIII-XIII in FIG. 9.

FIG. 14 is a perspective view showing a connector assembly in a state where the connection of the male connector and the female connector is completed.

FIG. 15 is a plan view showing the connector assembly in the state where the connection of the male connector and the female connector is completed.

FIG. 16 is a side view showing the connector assembly in the state where the connection of the male connector and the female connector is completed.

FIG. 17 is a section along XVII-XVII in FIG. 15.

FIG. 18 is a section along XVIII-XVIII in FIG. 15.

FIG. 19 is a section along XIX-XIX in FIG. 10.

FIG. 20 is a section along XX-XX in FIG. 16.

FIG. 21 is a plan view showing the male connector and the female connector in a connection intermediate state.

FIG. 22 is a side view showing the male connector and the female connector in the connection intermediate state.

FIG. 23 is a section along XXIII-XXIII in FIG. 21.

FIG. 24 is a section along XXIV-XXIV in FIG. 21.

FIG. 25 is a section along XXV-XXV in FIG. 21.

FIG. 26 is a section corresponding to XIX-XIX in FIG. 10 showing an identifier according to another embodiment (5).

FIG. 27 is a section corresponding to XX-XX in FIG. 16 showing the identifier according to the other embodiment (5).

### DETAILED DESCRIPTION TO EXECUTE THE INVENTION

### Description of Embodiments of Present Disclosure

First, embodiments of the present disclosure are listed and described.
(1) The connector of the present disclosure is to be connected to a mating connector and provided with a terminal, a housing for accommodating the terminal and a retainer to be movably assembled with the housing, the housing including a resiliently deformable locking lance for locking the terminal, the retainer including a restricting portion for restricting resilient deformation of the locking lance by entering a resilient deformation space, the locking lance being resiliently deformed into the resilient deformation space, the retainer being movable between a retracted position where the restricting portion is retracted from the resilient deformation space and a locking position where the restricting portion is located in the resilient deformation space with the terminal locked by the locking lance, and the retainer further moving between the locking position and a completion position indicating the completion of connection of the housing and the mating connector as the mating connector and the housing are connected.

The completion of the connection of the mating connector and the connector can be confirmed by confirming a movement of the retainer from the locking position to the completion position. In this way, an operation of separately moving a connection assurance member becomes unnecessary after a connecting operation of the mating connector and the connector, wherefore the efficiency of a connector assembly operation can be improved.
(2) Preferably, a detection window for at least partially exposing the retainer is open at a position corresponding to the retainer at the completion position in the housing.

The completion of the connection of the mating connector and the connector can be confirmed by confirming that the retainer is at least partially exposed through the detection window.
(3) Preferably, the retainer includes an identifier detectable by a predetermined machine on a part exposed through the detection window at the completion position. The completion of the connection of the mating connector and the connector can be confirmed by detecting the exposure of the identifier through the detection window by the machine.
(4) Preferably, the identifier is provided on an arrangement surface provided on the retainer, and the arrangement surface is inclined with respect to a wall part formed with the detection window, out of the housing.

Since the arrangement surface is inclined with respect to the wall part of the housing, a focal length between the machine and the identifier can be varied partially in the arrangement surface in detecting the identifier through the detection window by the machine.
(5) Preferably, a viewing window for exposing the identifier is open at a position corresponding to the identifier with the retainer moved to the locking position in the housing, and the housing is provided with a blocking portion for blocking detection of the identifier through the viewing window by the predetermined machine.

Since the blocking portion makes it impossible for the machine to detect the identifier through the detection window, the identifier is not detected by the machine with the retainer moved to the locking position. In this way, it is suppressed that the identifier is erroneously detected by the machine in a state where the mating connector and the connector are not properly connected.

On the other hand, since the identifier can be visually confirmed through the viewing window, the position of the identifier can be grasped in advance. Therefore, the identifier can be reliably found at the completion position.
(6) Preferably, the blocking portion is a rib projecting outward from a hole edge part of the detection window.

The blocking portion can be formed by a simple configuration of providing the rib.
(7) A connector assembly of the present disclosure is provided with the connector of any one of (1) to (6) described above and a mating connector to be connected to the connector.
(8) Preferably, the mating connector includes a contact portion for moving the retainer from the locking position to the completion position by contacting the retainer from a connection direction to the connector when the mating connector is connected to the connector.

The retainer can be moved from the locking position to the completion position by connecting the mating connector and the connector. In this way, an operation of separately moving a connection assurance member becomes unnecessary after a connecting operation of the mating connector and the connector, wherefore work efficiency can be improved.
(9) Preferably, the mating connector includes a locking portion projecting toward the connector and to be locked to the retainer, the retainer is moved from the completion position to the locking position by locking the locking portion to the retainer in separating the mating connector and the connector, and locking of the locking portion and the retainer is released when the retainer is moved to the locking position.

The retainer can be moved from the completion position to the locking position by an operation of separating the mating connector and the connector. In this way, an operation of moving the retainer from the completion position to the locking position becomes unnecessary after the mating connector and the connector are separated.

### Details of Embodiment of Present Disclosure

Hereinafter, an embodiment of the present disclosure is described. The present disclosure is not limited to these illustrations, but is represented by claims and intended to include all changes in the scope of claims and in the meaning and scope of equivalents.

### Embodiment

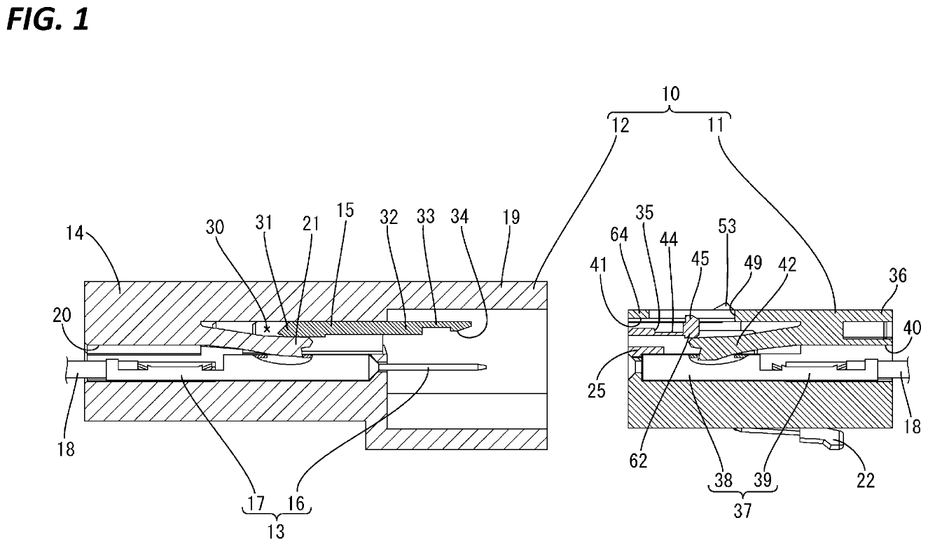

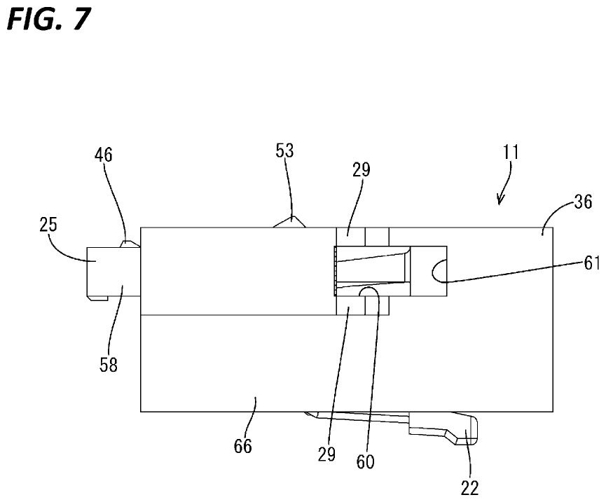

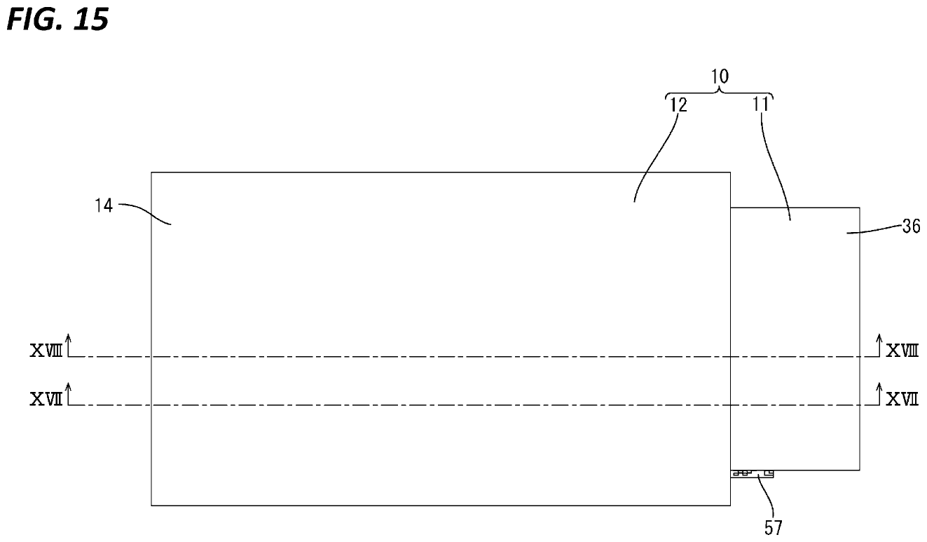

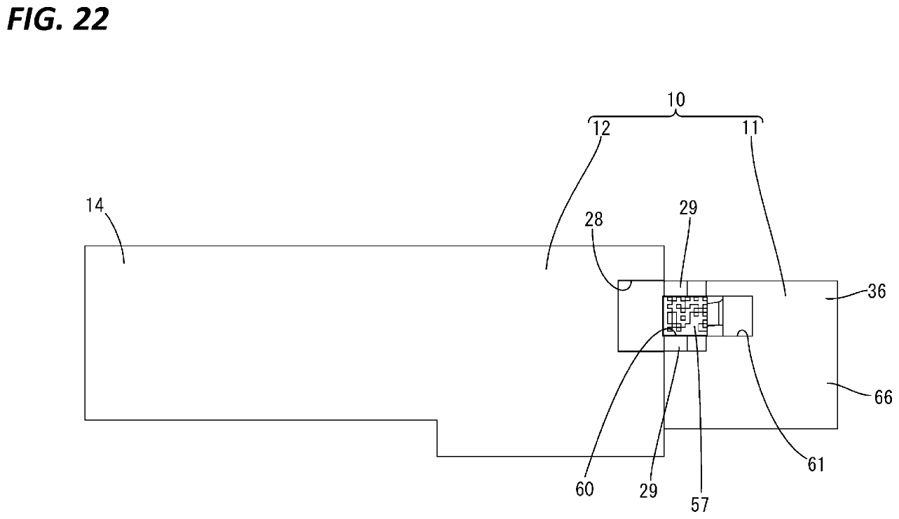

One embodiment of the present disclosure is described with reference to FIGS. 1 to 25. As shown in FIG. 1, a connector assembly 10 according to this embodiment includes a female connector (an example of a connector) and a male connector 12 (an example of a mating connector).

In the following description, a vertical direction is based on a vertical direction in FIG. 1. Connection directions of the male connector 12 and the female connector 11 to each other in FIG. 1 are referred to as forward directions concerning a front-rear direction. Left and right sides toward the front in the connection direction of the male connector 12 and the female connector 11 are referred to as left and right sides for each of the male connector 12 and the female connector 11 concerning a lateral direction. Further, for a plurality of identical members, only some members may be denoted by a reference sign and the others may not be denoted by the reference sign.

### [Male Connector 12]

As shown in FIG. 1, the male connector 12 is provided with male terminals 13, a male housing 14 for accommodating the male terminals 13 and a male retainer 15 to be mounted into the male housing 14.

The male terminal 13 is formed by press-working a metal plate material into a predetermined shape. The male terminal 13 includes a plate-like tab 16 projecting forward and a wire connecting portion 17 connected behind the tab 16 and to be connected to a wire 18. By crimping the wire connecting portion 17 to the outer periphery of the wire 18, the wire 18 and the wire connecting portion 17 are electrically connected.

The male housing 14 has a rectangular parallelepiped shape as a whole and made of insulating synthetic resin. The male housing 14 includes a receptacle 19 open forward. The tabs 16 of the male terminals 13 are disposed to project forward in the receptacle 19. A plurality of (five in this embodiment) male cavities 20 for accommodating the male terminals 13 are formed at intervals in the lateral direction in the male housing 14. A male locking lance 21 extending to project forward and resiliently deformable is formed inside the male cavity 20. A front end part of the male locking lance 21 locks the male terminal 13 from behind, whereby the male terminal 13 is held retained in the male cavity 20. A lock receiving portion 24, into which a lock portion 23 of a lock arm 22 to be described later is fit, is provided to penetrate through the lower wall of the receptacle 19. A pressing projection 26 for pressing a female retainer 25 to be described later is provided to project downward on the upper wall of the receptacle 19.

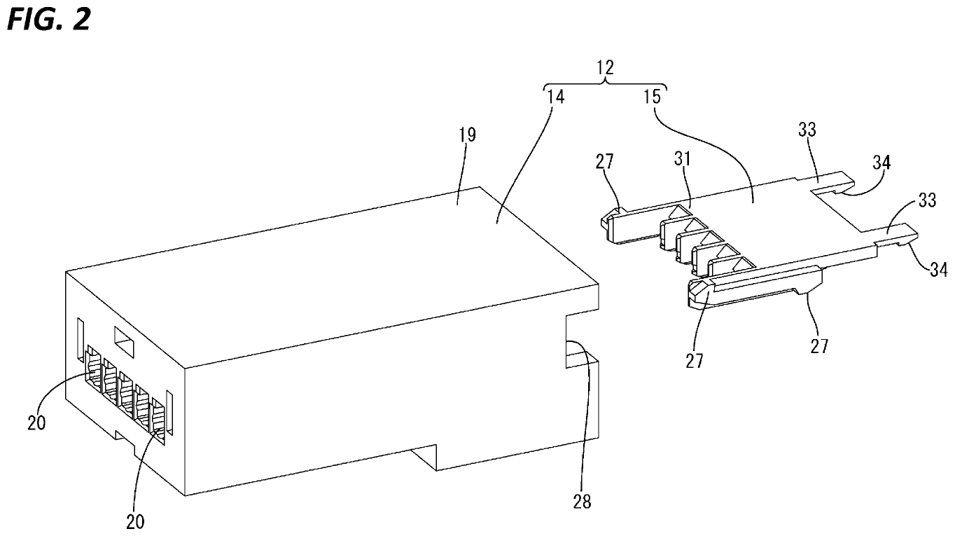

The male retainer 15 is assembled from front with a rear wall provided behind the receptacle 19. The male retainer 15 is in the form of a vertically flat plate as a whole and made of insulating synthetic resin. As shown in FIG. 2, lock portions 27 to be resiliently locked to the male housing 14 are provided on both left and right end parts of the male retainer 15. The male retainer 15 is fixed to the male housing 14 by locking the lock portions 27 to the male housing 14.

As shown in FIG. 1, a recess 28 recessed rearward is formed in a front end part of the right side wall of the receptacle 19. By this recess 28, the interference of ribs 29 to be described later and the receptacle 19 can be avoided with the male connector 12 and the female connector 11 connected. A vertical dimension of the recess 28 is larger than an interval between the upper surface of the upper rib 29 and the lower surface of the lower rib 29.

The male retainer 15 includes a restricting portion 31 for preventing the male locking lances 21 from being resiliently deformed by entering a resilient deformation space 30, into which the male locking lances 21 of the male housing 14 are resiliently deformed, from front. The restricting portion 31 is formed to project rearward from a rear end part of the male retainer 15 at a position corresponding to the male locking lances 21 of the male housing 14.

A contact portion 32 projecting forward and configured to come into contact with the female retainer 25 to be described later is formed on a front upper end part of the male retainer 15. The contact portion 32 is in the form of a vertically flat plate. Arm portions 33 projecting from both left and right end parts are formed on a front end part of the contact portion 32. The arm portion 33 is elongated in the front-rear direction. A locking portion 34 projecting downward is formed on a front end part of the arm portion 33. The locking portion 34 is locked to a lock receiving portion 35 of the male retainer 25 to be described later. The rear end surface of the locking portion 34 is formed to steeply extend from the lower surface of the arm portion 33. On the other hand, the front end surface of the locking portion 34 is formed to be gently inclined with respect to the front-rear direction.

### [Female Connector 11]

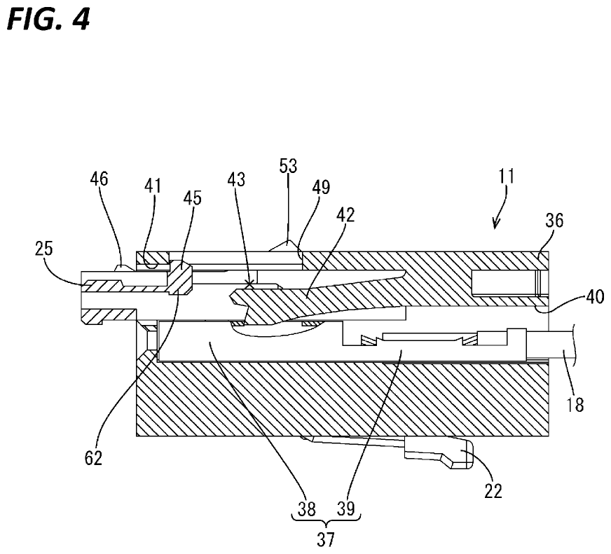

As shown in FIG. 4, the female connector 11 is provided with a female housing 36 (an example of a housing), female terminals 37 (an example of a terminal) to be accommodated into the female housing 36 and the female retainer 25 (an example of a retainer) to be mounted into the female housing 36 from front.

The female terminal 37 is formed by press-working a metal plate material into a predetermined shape. The female terminal 37 includes a connecting tube portion 38, into which the tab 16 of the male terminal 13 is inserted, and a wire connecting portion 39 connected behind the connecting tube portion 38 and to be connected to a wire 18. If the tab 16 is inserted into the connecting tube portion 38, a resilient contact piece (not shown) disposed in the connecting tube portion 38 and the tab 16 resiliently contact. In this way, the male terminal 13 and the female terminal 37 are electrically connected. Further, by crimping the wire connecting portion 39 to the outer periphery of the wire 18, the wire 18 and the wire connecting portion 39 are electrically connected.

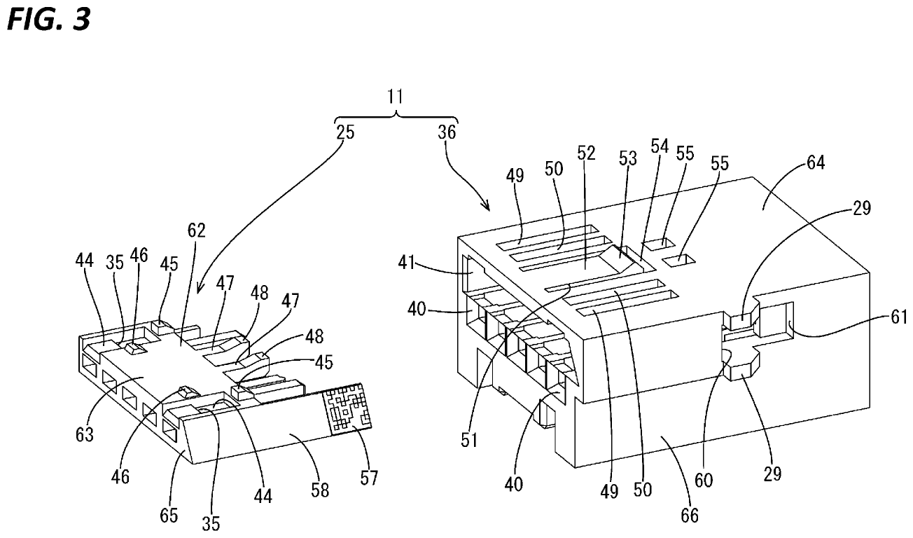

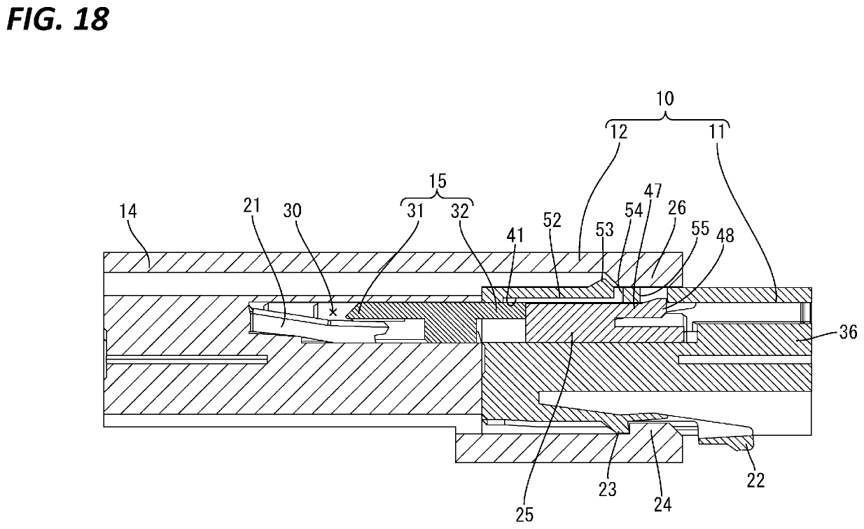

As shown in FIG. 3, the female housing 36 has a rectangular parallelepiped shape as a whole. The female housing 36 is made of insulating synthetic resin. As shown in FIG. 4, the lock arm 22 extending rearward from a front end part is formed on the lower surface of the female housing 36. The lock arm 22 is resiliently deformable in the vertical direction. The lock portion 23 projecting downward is formed near a center of the lock arm 22 in the front-rear direction (see FIG. 18).

As shown in FIG. 3, the female housing 36 includes a plurality of (five in this embodiment) female cavities 40 open forward and rearward. The female terminal 37 is accommodated into the female cavity 40 from behind. The female cavities 40 are formed side by side at intervals in the lateral direction near a center position of the female housing 36 in the vertical direction.

A retainer accommodating portion 41 for accommodating the female retainer 25 is formed to be open forward at a position above the female cavities 40 in a front end part of the female housing 36. A hole edge part of the retainer accommodating portion 41 is elongated in the lateral direction and formed to have a flat shape in the vertical direction. The retainer accommodating portion 41 and the female cavities 40 communicate in the vertical direction.

As shown in FIG. 4, female locking lances 42 (an example of a locking lance) cantilevered obliquely to a front lower side are formed at positions corresponding to the respective female cavities 40 on the upper wall of the retainer accommodating portion 41. The female locking lance 42 is resiliently displaceable toward a resilient deformation space 43 provided above the female locking lance 42. If the female terminal 37 is inserted to a proper insertion position of the female cavity 40, the female locking lance 42 and the female terminal 37 are locked in the front-rear direction, whereby the female terminal 37 is held in the female housing 36 while being prevented from coming out rearward. The resilient deformation space 43 for the female locking lances 42 is set in the retainer accommodating portion 42.

The female retainer 25 is mounted into the retainer accommodating portion 41 of the female housing 36 from front. As shown in FIG. 3, the female retainer 25 is in the form of a vertically flat plate as a whole. The female retainer 25 is made of insulating synthetic resin.

A part of the female retainer 25 near a rear end part of an upper wall 63 serves as a restricting portion 62 for preventing the female locking lances 42 from being resiliently deformed by entering the resilient deformation space 30 for the female locking lances 42 with the female terminals 37 locked by the female locking lances 42.

Locking recesses 44 recessed downward are respectively formed at positions near both left and right end parts of the upper surface of the upper wall 63 of the female retainer 25. The locking recess 44 is formed to be elongated in the front-rear direction. Two locking recesses 44 are formed to have the same shape and size. Note that the same shape and size mean not only a case of being the same shape and size, but also a case of not being the same shape and size, but being recognizable as substantially the same shape and size.

The locking recess 44 is formed to be depressed in two stages in the front-rear direction such that a rear side is deeper. In other words, a depression depth from the upper surface of the female retainer 25 is larger in a rear part than in a front part. In this way, a step is formed between the front part and the rear part in the locking recess 44, and this step serves as the lock receiving portion 35 to be locked by the locking portion 34 of the male retainer 15.

### [Locking Structure]

As shown in FIG. 3, first locking portions 45 projecting upward are formed at positions behind the locking recesses 44 on the upper surface of the female retainer 25. The front end surface of the first locking portion 45 is formed to extend steeply upward from the upper surface of the female retainer 25. The rear end surface of the first locking portion 45 is formed to be gently inclined with respect to the front-rear direction. Two first locking portions 45 are formed to have same shape and size.

Second locking portions 46 projecting upward are respectively formed at positions inward of the locking recesses 44 in the lateral direction on the upper surface of the female retainer 25. In other words, the second locking portions 46 are respectively formed at a position to the right of the locking recess 44 formed on a left side and a position to the left of the locking recess 44 formed on a right side. The front end surface of the second locking portion 46 is formed to extend steeply upward from the upper surface of the female retainer 25. An angle of inclination of the front end surface of the second locking portion 46 from the upper surface of the female retainer 25 is gentler than that of the front end surface of the first locking portion 45. The rear end surface of the second locking portion 46 is formed to be gently inclined with respect to the front-rear direction. Two second locking portions 46 are formed to have same shape and size.

Two arm portions 47 projecting rearward from the vicinity of a center position in the lateral direction are formed in a rear end part of the female retainer 25. The two arm portions 47 are formed to have the same shape and size. A third locking portion 48 projecting upward is formed on a rear end part of the arm portion 47. The front end surface of the third locking portion 48 is formed to be gently inclined with respect to the front-rear direction. The rear end surface of the third locking portion 48 is formed to be orthogonal to the upper surface of the female retainer 25. Note that orthogonal means not only a case of being orthogonal, but also a case of not being orthogonal, but being recognizable as substantially orthogonal.

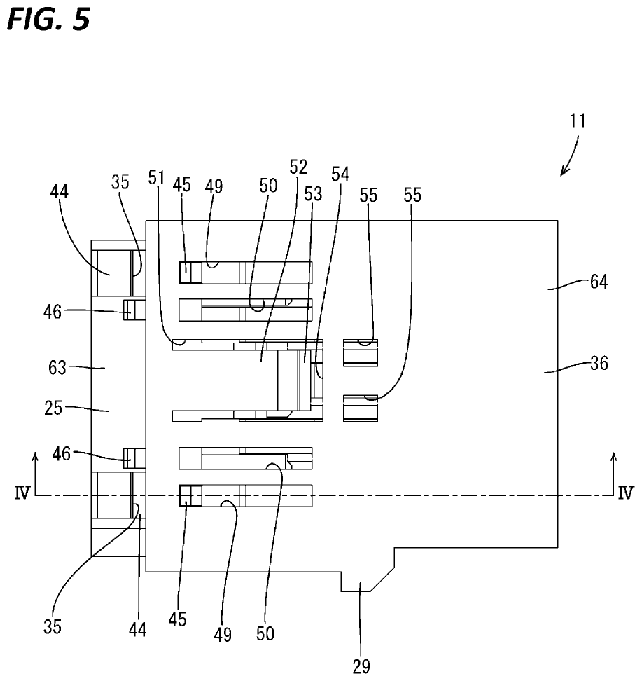

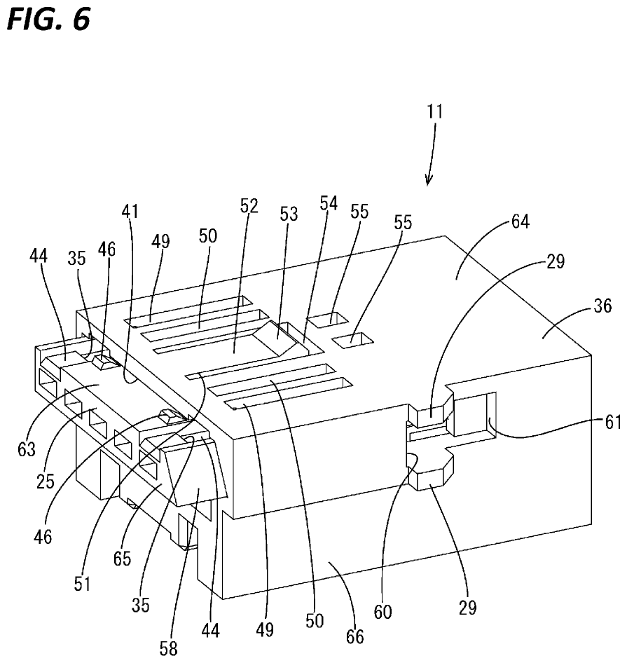

As shown in FIGS. 5 and 6, an upper wall 64 of the female housing 36 is formed with first lock receiving portions 49 extending in the front-rear direction and penetrating through the upper wall 64 in the vertical direction at positions corresponding to the first locking portions 45 with the female retainer 25 accommodated in the retainer accommodating portion 41. The first lock receiving portions 49 are formed at positions near both left and right end parts of the upper wall 64 of the female housing 36. The first locking portion 49 has a rectangular shape when viewed from above. The two first lock receiving portions 49 are formed to have the same shape and size.

The upper wall 64 of the female housing 36 is formed with second lock receiving portions 50 extending in the front-rear direction and penetrating through the upper wall 64 in the vertical direction at positions corresponding to the second locking portions 46 with the female retainer 25 accommodated in the retainer accommodating portion 41. The second lock receiving portions 50 are formed inwardly of the first lock receiving portions 49 in the lateral direction in the upper wall 64 of the female housing 36. In other words, the second lock receiving portion 50 is formed to the right of the first lock receiving portion 49 formed on a left side of the upper wall 64 of the female housing 36, and the second lock receiving portion 50 is formed to the left of the first lock receiving portion 49 formed on a right side. The second locking portion 50 has a rectangular shape when viewed from above. The two second lock receiving portions 50 are formed to have the same shape and size.

The upper wall 64 of the female housing 36 is formed with an angular C-shaped slit 51 near a center in the lateral direction when viewed from above. The slit 51 includes two parts arranged at an interval in the lateral direction and extending in the front-rear direction and a part coupling rear end parts of these two parts. A resilient deforming portion 52 extending in the front-rear direction is formed in a region surrounded by this slit 51. The resilient deforming portion 52 is formed above the arm portions 47 of the female retainer 25 with the female retainer 25 accommodated in the retainer accommodating portion 41. A projection 53 projecting upward is formed on a rear end part of the resilient deforming portion 52. The front and rear end surfaces of the projection 53 are formed to be gently inclined with respect to the front-rear direction.

The part extending in the lateral direction and located behind the resilient deforming portion 52, out of the slit 51, serves as a front third lock receiving portion 54 lockable to the third locking portions 48 of the female retainer 25. Further, the upper wall 64 of the female housing 36 is formed with two rear third lock receiving portions 55 arranged at an interval in the lateral direction and penetrating through the upper wall 64 in the vertical direction at positions behind the third lock receiving portion 54. The rear third lock receiving portion 55 has a rectangular shape when viewed from above. The rear third lock receiving portions 55 are lockable to the third locking portions 48 of the female retainer 25.

### [Assembly Structure of Female Housing 36 and Female Retainer 25]

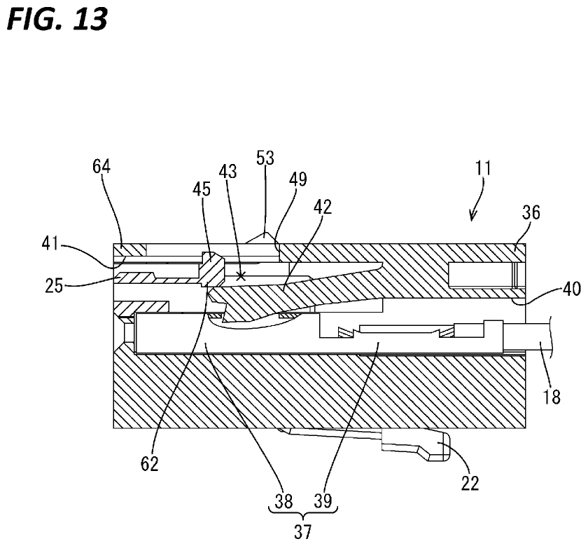

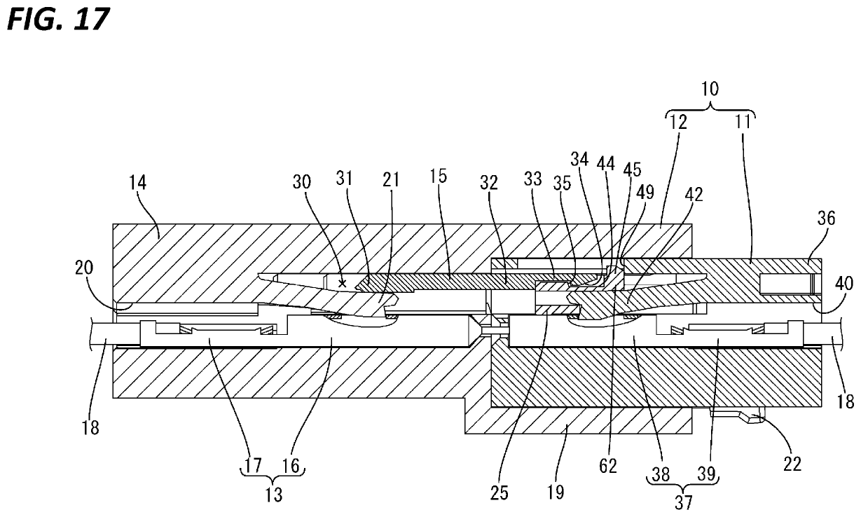

The female retainer 25 is mounted movably between a retracted position (see FIG. 3), a locking position (see FIG. 13) behind the retracted position and a completion position (see FIG. 17) behind the locking position.

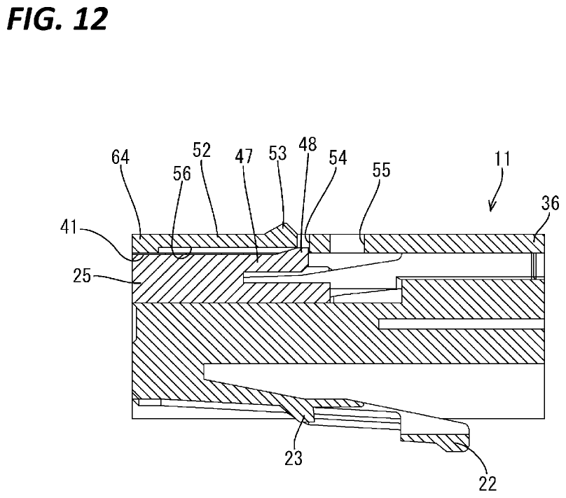

FIGS. 4 to 7 show a state where the female retainer 25 is assembled with the female housing 36 at the retracted position. As shown in FIGS. 4 and 5, with the female retainer 25 assembled with the female housing 36 at the retracted position, the front end surfaces of the first locking portions 45 are in contact with the front walls of the first lock receiving portions 49 from behind. In this way, the female retainer 25 is held in the female housing 36 while being prevented from coming out forward. As shown in FIGS. 4 to 7, the rear end surfaces of the second locking portions 46 are in contact with the front surface of the female housing 36 from front. In this way, the female retainer 25 is held in the female housing 36 with a rearward movement restricted. As shown in FIG. 12, an escape recess 56 recessed upward is formed in a lower part of the resilient deforming portion 52 of the female housing 36 to avoid the interference of the third locking portions 48 and the resilient deforming portion 52. In this way, the interference of the third locking portions 48 and the resilient deforming portion 52 is prevented with the female retainer 25 assembled with the female housing 36 at the retracted position. As shown in FIG. 4, the restricting portion 62 is retracted in front of the resilient deformation space 43. In this way, the female locking lances 42 are resiliently deformable into the resilient deformation space 43.

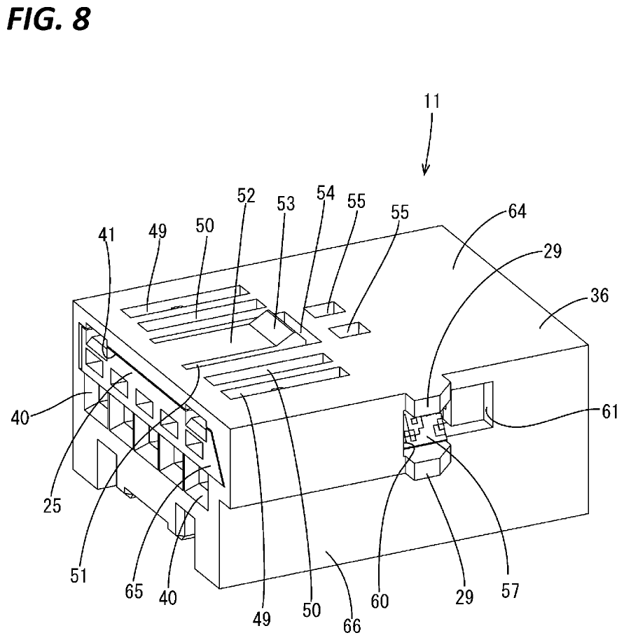

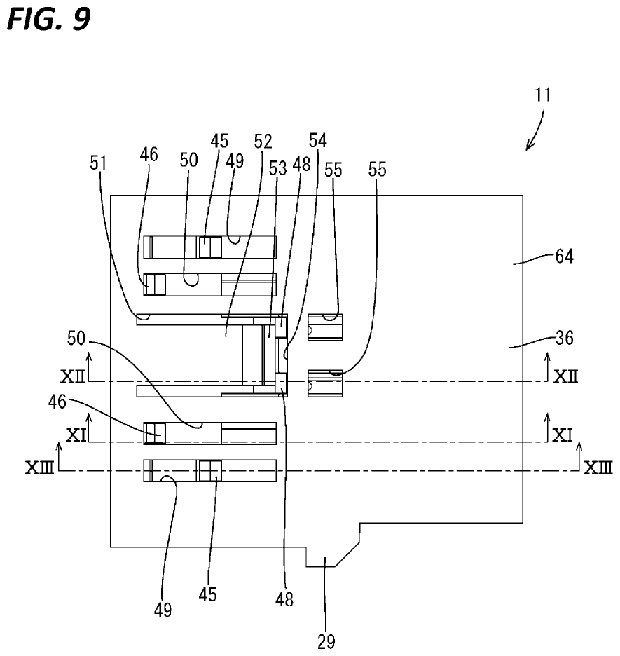

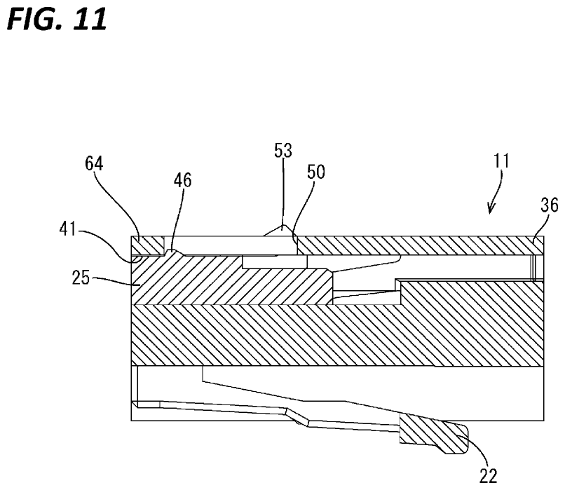

FIGS. 8 to 13 show a state where the female retainer 25 is assembled with the female housing 36 at the locking position. As shown in FIGS. 9 and 11, the second locking portions 46 are in contact with the front walls of the second lock receiving portions 50 from behind. In this way, the female retainer 25 is held in the female housing 36 while being prevented from coming out forward. As shown in FIG. 12, the third locking portions 48 are in contact with the rear wall of the front third lock receiving portion 54 from front. In this way, the female retainer 25 is held in the female housing 36 with a rearward movement restricted. As shown in FIG. 13, the restricting portion 62 is located in the resilient deformation space 43. In this way, the female locking lances 42 are prevented from being resiliently deformed.

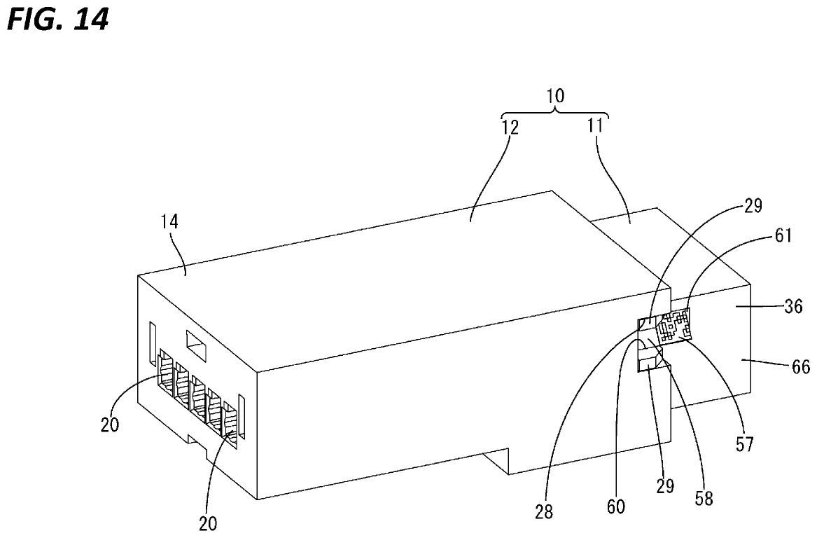

FIGS. 14 to 18 show a state where the female retainer 25 is assembled with the female housing 36 at the completion position. As shown in FIGS. 17 and 18, the contact portion 32 of the male retainer 15 is in contact with the front end surface of the female retainer 25. In this way, a forward movement of the female retainer 25 is restricted. As shown in FIG. 18, the third locking portions 48 are in contact with the rear walls of the rear third lock receiving portions 55 from front. In this way, the female retainer 25 is held in the female housing 36 with a rearward movement restricted.

### [Identifier]

As shown in FIG. 3, a left side wall 65 of the female retainer 25 is formed to be inclined obliquely upward from left to right. The left side wall 65 of the female retainer 25 extends rearward from the rear end part of the female retainer 25. An identifier 57 is formed on a rear end part of the left side wall 65 of the female retainer 25. The left side surface of the left side wall 65 serves as an arrangement surface 58 provided with the identifier 57. Any one of a one-dimensional code, a two-dimensional code and a three-dimensional code may be used as the identifier 57, but a two-dimensional code is used in this embodiment. Further, although the identifier 57 of this embodiment is printed by applying laser processing to the arrangement surface 58, but a plate-like code formed separately from the arrangement surface 58 may be adhered to the arrangement surface 58.

Information such as “connection completion” and a “lot number” are recorded as the two-dimensional code in the identifier 57. Using a predetermined machine 59 such as a reader or a camera, this identifier 57 can be read and the read information can be recorded in a recording device. For example, by detecting the identifier 57 and reading the information by the machine 59 after the female connector 11 and the male connector 12 are connected, it can be recorded in the recording device that the connection of the female connector 11 and the male connector 12 has been completed. The machine 59 according to this embodiment has an auto-focus adjustment function for automatically focusing on the identifier 57 in reading the identifier 57. The machine 59 may be handheld or attached.

### [Viewing Window]

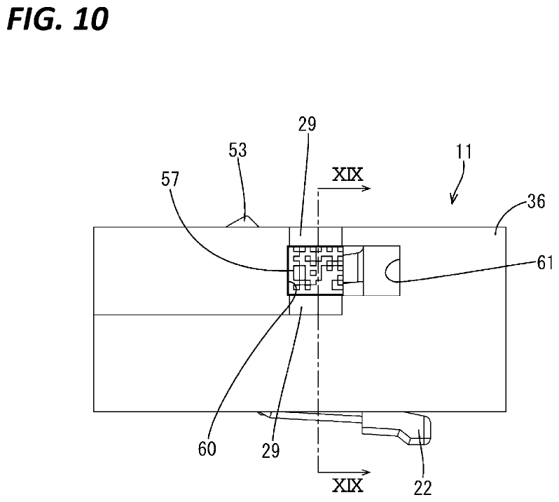

As shown in FIG. 10, a left side wall 66 of the female housing 36 is formed with a viewing window 60 penetrating in the lateral direction at a position corresponding to the identifier 57 of the female retainer 25 with the female retainer 25 assembled with the female housing 36 at the locking position. The viewing window 60 has a rectangular shape when viewed from left. When viewed from left, the identifier 57 is entirely or partially exposed through the viewing window 60. In this way, the identifier 57 can be entirely or partially visually recognized through the viewing window 60.

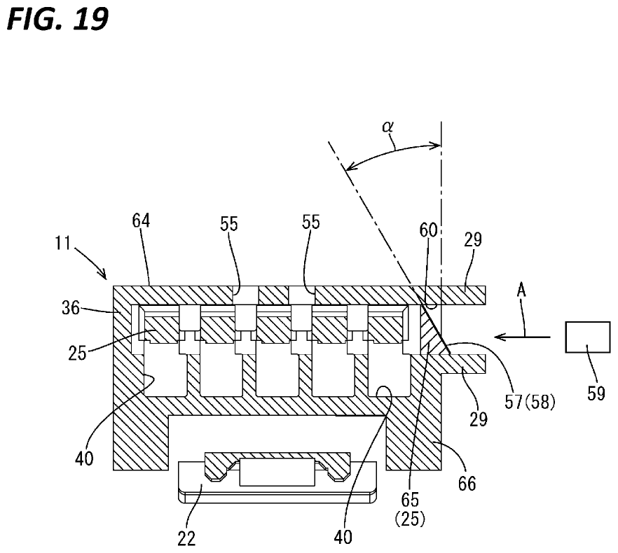

As shown in FIG. 19, an angle α formed by the outer surface of the left side wall 66 of the female housing 36 and the arrangement surface 58 of the female retainer 25 can be arbitrarily set and is preferably in a range of 0° to 45°. In this embodiment, the angle α is set to 30°.

The left side wall 66 of the female housing 36 is formed with the ribs 29 (an example of a blocking portion) projecting leftward from upper and lower edge parts of the viewing window 60. Lengths in the front-rear direction of the ribs 29 are set equal to those of the upper and lower edge parts of the viewing window 60. The front end edge of the rib 29 is formed to steeply extend from the left side surface of the left side wall 66 of the female housing 36. The rear end edge of the rib 29 is formed to be gently inclined rightward toward the rear.

### [Detection Window]

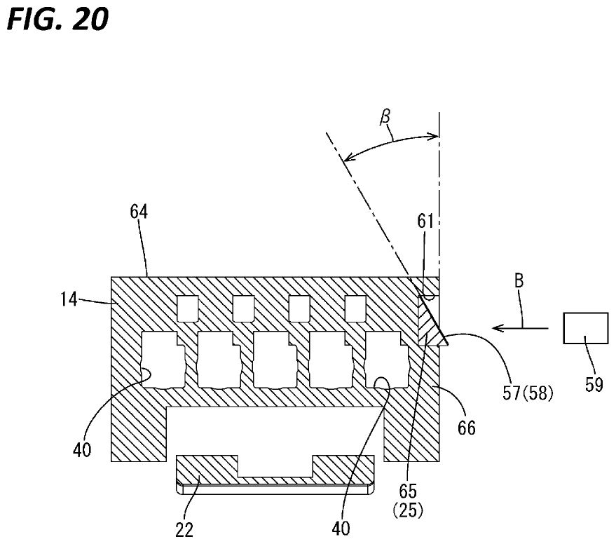

As shown in FIG. 20, a detection window 61 is formed to be open leftward at a position behind the viewing window 60 in the left side wall 66 of the female housing 36. The detection window 61 has a rectangular shape when viewed from left. The detection window 61 is formed at a position corresponding to the identifier 57 of the female retainer 25 with the female retainer 25 assembled with the female housing 36 at the completion position. When viewed from left, the identifier 57 is entirely exposed through the detection window 61. In this way, the identifier 57 can be read through the detection window 61 by the machine 59.

The viewing window 60 and the detection window 61 may communicate in the front-rear direction or may be formed side by side at an interval in the front-rear direction. In this embodiment, the viewing window 60 and the detection window 61 communicate in the front-rear direction.

### [Assembly Process of Connector Assembly]

Next, an assembly process of the connector assembly 10 is described. Note that the assembly process of the connector assembly 10 is not limited to the one described below.

The male terminal 13 is inserted into the male cavity 20 of the male housing 14 from behind. By the contact of the male terminal 13 with the male locking lance 21, the male locking lance 21 is resiliently deformed into the resilient deformation space 30. If the male terminal 13 is further pushed forward, the male locking lance 21 is restored, whereby the front end part of the male locking lance 21 comes into contact with the male terminal 13 from behind. In this way, the male terminal 13 is accommodated in the male housing 14 while being prevented from coming out rearward.

The male retainer 15 is inserted into the male cavities 20 from front. By the entrance of the restricting portion 31 of the male retainer 15 into the resilient deformation space 30 for the male locking lances 21, the resilient deformation of the male locking lances 21 is restricted. By the resilient engagement of the lock portions 27 of the male retainer 15 with the male housing 14, the male retainer 15 is assembled with the male housing 14 while being prevented from coming out forward (see FIG. 1).

The female retainer 25 is inserted into the retainer accommodating portion 41 of the female housing 36 from front. By the contact of the first locking portions 45 of the female retainer 25 and the upper wall 64 of the female housing 36, the upper wall 64 of the female housing 36 is deformed to ride on the first locking portions 45. If the female retainer 25 is further pushed rearward, the upper wall 64 of the female housing 36 is restored and the first locking portions 45 enter the first lock receiving portions 49 of the female housing 36. By the contact of the front end parts of the first locking portions 45 with the front walls of the first lock receiving portions 49 from behind, the female retainer 25 is held in the female housing 36 while being stopped in front. Further, by the contact of the rear end parts of the second locking portions 46 with the front end edge of the upper wall 64 of the female housing 36 from front, a rearward movement of the female retainer 25 is restricted. In this way, the female retainer 25 is assembled with the female housing 36 at the retracted position.

With the female retainer 25 assembled with the female housing 36 at the retracted position, the restricting portion 62 of the female retainer 25 is located in front of the resilient deformation space 43 of the female housing 36. In this way, the female locking lances 42 of the female housing 36 are resiliently deformable.

The female terminal 37 is inserted into the female cavity 40 of the female housing 36 from behind. By the contact of the female terminal 37 with the female locking lance 42, the female locking lance 42 is resiliently deformed into the resilient deformation space 30. If the female terminal 37 is further pushed forward, the female locking lance 42 is restored, whereby the front end part of the female locking lance 42 comes into contact with the female terminal 37 from behind. In this way, the female terminal 37 is accommodated in the female housing 36 while being prevented from coming out rearward (see FIG. 4).

By pushing the female retainer 25 rearward, the rear end parts of the second locking portions 46 come into contact with the front end edge of the upper wall 64 of the female housing 36 from front. In this way, the upper wall 64 of the female housing 36 is deformed to ride on the second locking portions 46.

If the female retainer 25 is further pushed rearward, the upper wall 64 of the female housing 36 is restored and the second locking portions 46 enter the second lock receiving portions 50 of the female housing 36. By the contact of the front end parts of the second locking portions 46 with the front walls of the second lock receiving portions 50 from behind, the female retainer 25 is held in the female housing 36 while being stopped in front. Further, by the contact of the rear end parts of the third locking portions 48 with the rear wall of the front third lock receiving portion 54 from front, the female retainer 25 is held in the female housing 36 with a rearward movement restricted. In this way, the female retainer 25 is assembled with the female housing 36 at the locking position.

With the female retainer 25 assembled with the female housing 36 at the locking position, the restricting portion 62 of the female retainer 25 is located in the resilient deformation space 43 of the female housing 36. In this way, the female locking lances 42 of the female housing 36 are prevented from being resiliently deformed. As a result, the female terminals 37 are doubly locked by the female locking lances 42 and the female retainer 25 (see FIG. 13).

Subsequently, the male connector 12 and the female connector 11 are arranged to face each other and connected toward each other (see FIG. 1).

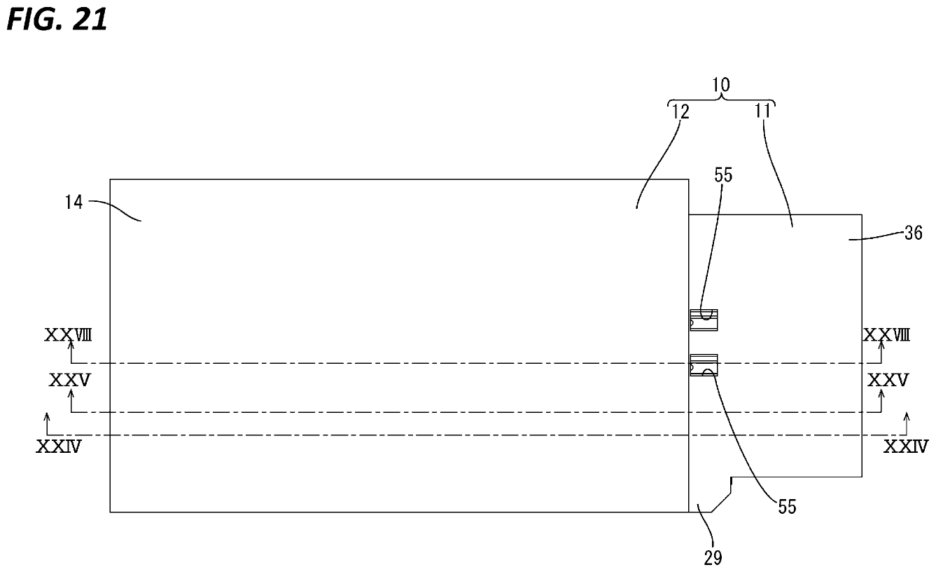

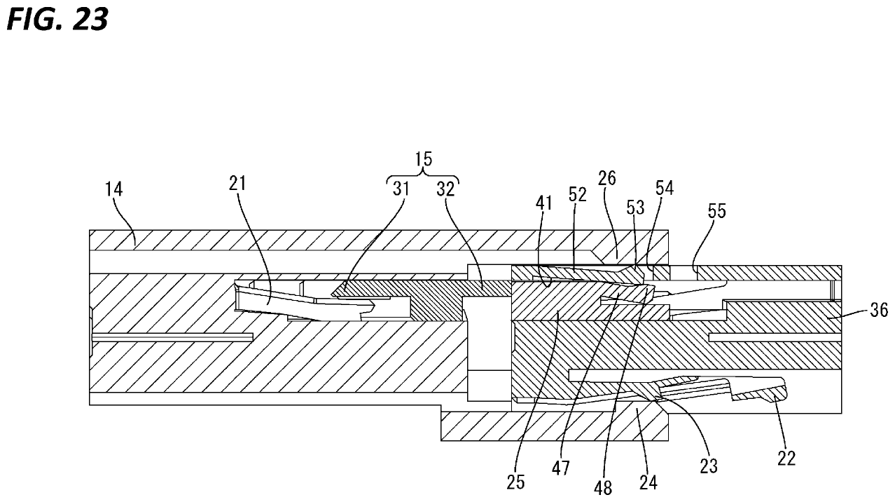

As shown in FIGS. 21 to 24, the front end part of the female connector 11 is fit into the receptacle 19 of the male connector 12. Then, as shown in FIG. 23, the front end edge of the lower wall of the receptacle 19 comes into contact with the lock portion 23 of the lock arm 22 of the female housing 36 from front. In this way, the lock arm 22 is resiliently deformed upward. If the male connector 12 is further pushed forward, the lock arm 22 is restored and the lock portion 23 enters the lock receiving portion 24 of the receptacle 19 of the male connector 12. In this way, the male connector 12 and the female connector 11 are held retained (see FIG. 18).

If the female connector 11 is fit into the receptacle 19 of the male connector 12 as shown in FIG. 23, the pressing projection 26 of the receptacle 19 comes into contact with the projection 53 of the resilient deforming portion 52 of the female housing 36 from front. Then, the resilient deforming portion 52 is resiliently deformed downward. If the resilient deforming portion 52 is resiliently deformed downward, the arm portions 47 of the female retainer 25 located below the resilient deforming portion 52 are resiliently deformed downward. Then, the third locking portions 48 of the arm portions 47 move downward, and the third locking portions 48 and the rear wall of the front third lock receiving portion 54 are disengaged.

If the male connector 12 is further pushed forward, the front end part of the contact portion 32 of the male retainer 15 comes into contact with the front end part of the female retainer 25. In this way, the female retainer 25 moves rearward.

If the male connector 12 is further pushed forward, the resilient deforming portion 52 of the female housing 36 is restored and the projection 53 of the resilient deforming portion 52 is located in front of the pressing projection 26 of the receptacle 19. Then, the arm portions 47 of the female retainer 25 located below the resilient deforming portion 52 are also restored, and the third locking portions 48 of the arm portions 47 enter the rear third lock receiving portions 55. In this way, the rear end parts of the third locking portions 48 come into contact with the rear walls of the rear third lock receiving portions 55 from front and a rearward movement of the female retainer 25 is restricted. In this way, the female retainer 25 is assembled with the female housing 36 at the completion position (see FIG. 18).

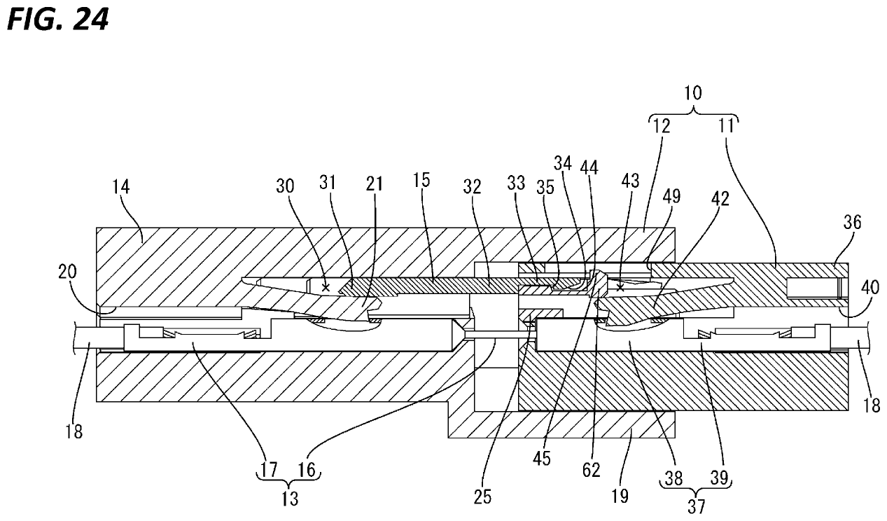

On the other hand, if the female connector 11 is fit into the receptacle 19 of the male connector 12, the front end parts of the arm portions 33 of the male retainer 15 come into contact with the front end edge of the female retainer 25. Then, the arm portions 33 are resiliently deformed to ride on the upper wall 63 of the female retainer 25. If the male connector 12 is further pushed forward, the arm portions 33 are restored and the locking portions 34 of the arm portions 33 enter the locking recesses 44 of the female retainer 25 (see FIG. 24).

### [Separation Process of Connector Assembly]

Next, a separation process of the male connector 12 and the female connector 11 is described. By resiliently deforming the lock arm 22 upward, the lock portion 23 of the female connector 11 and the lock receiving portion 24 of the male connector 12 are disengaged. Thereafter, pulling forces are applied to the male connector 12 and the female connector 11 to separate the male connector 12 and the female connector 11 from each other (see FIG. 23).

Then, the locking portions 34 of the arm portions 33 of the male retainer 15 come into contact with the locking portions 34 of the locking recesses 44 of the female retainer 25 from behind. In this way, a forward force is applied to the female retainer 25 (see FIG. 24).

If the female retainer 25 is pulled forward via the locking portions 34 by the male retainer 15, the arm portions 47 of the female retainer 25 are resiliently deformed to slip under the upper wall 64 of the female housing 36. In this way, the third locking portions 48 of the female retainer 25 and the rear third lock receiving portions 55 of the female housing 36 are disengaged (see FIG. 23).

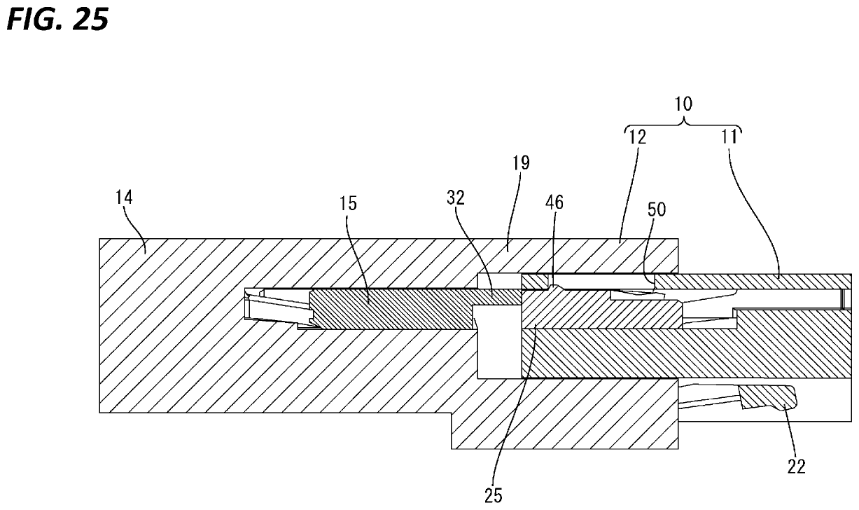

If the female retainer 25 is further pulled forward, the front end parts of the second locking portions 46 of the female retainer 25 come into contact with the front walls of the second lock receiving portions 50 from behind as shown in FIG. 25. Then, since a holding force between the second locking portions 46 of the female retainer 25 and the second lock receiving portions 50 of the female housing 36 is set larger than a holding force between the locking portions 34 of the male retainer 15 and the lock receiving portions 35 of the female retainer 25, the locking portions 34 of the male retainer 15 and the lock receiving portions 35 of the female retainer 25 are disengaged. Further, the arm portions 47 of the female retainer 25 are restored, whereby the third locking portions 48 enter the front third lock receiving portion 54. In this way, the female retainer 25 moves to the locking position with respect to the female housing 36 and is held at the locking position.

Further, by applying pulling forces to the male connector 12 and the female connector 11 to separate the male connector 12 and the female connector 11 from each other, the connection of the male connector 12 and the female connector 11 is released (see FIG. 1).

### [Visual Confirmation of Identifier]

As shown in FIG. 10, with the female retainer 25 assembled with the female housing 36 at the locking position, the identifier 57 is exposed to outside through the viewing window 60. Thus, a worker can visually confirm the identifier 57 through the viewing window 60. Thus, the worker can roughly recognize the position of the identifier 57 on the female housing 36.

On the other hand, the identifier 57 cannot be detected by the machine 59 through the viewing window 60. This is because the machine 59 is focused on tip parts of the ribs 29 near the machine 59 even if an attempt is made to detect the identifier 57 by the machine 59 from a direction indicated by an arrow A since the ribs 29 are formed on the upper and lower edge parts of the viewing window 60 as shown in FIG. 19. In other words, even if an attempt is made to detect the identifier 57 by the machine 59 from the direction indicated by the arrow A, the identifier 57 cannot be focused.

### [Detection of Identifier]

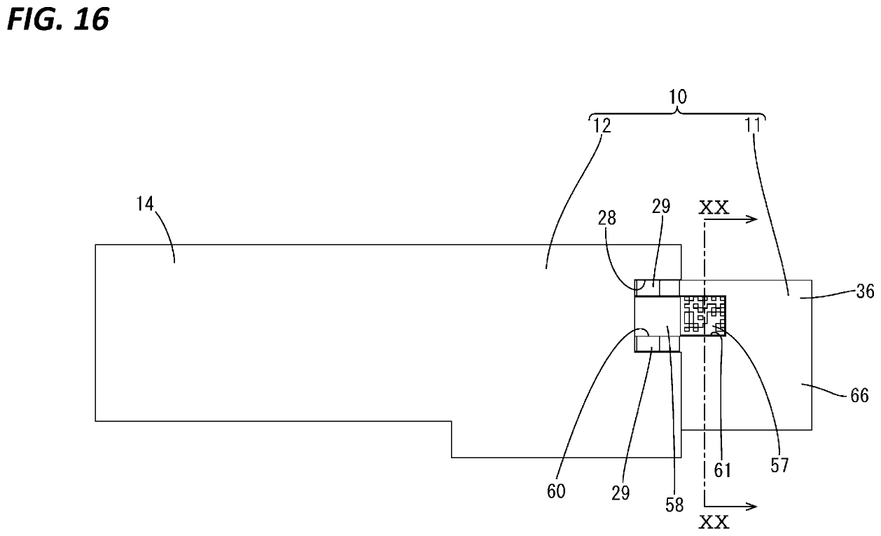

As shown in FIG. 16, with the female retainer 25 assembled with the female housing 36 at the completion position, the identifier 57 is exposed to outside through the detection window 61. Since the detection window 61 is not provided with the ribs 29 unlike the viewing window 60 as shown in FIG. 20, the machine 59 can detect the identifier 57 with the identifier 57 focused by the auto-focus adjustment function of the machine 59.

The identifier 57 can be detected from a direction indicated by an arrow B. As shown in FIG. 20, the arrangement surface 58 is inclined with respect to the outer surface of the left side wall 66 of the female housing 36. An angle β formed by the outer surface of the left side wall 66 of the female housing 36 and the arrangement surface 58 can be arbitrarily set and is preferably in a range of 0° to 45°. In this embodiment, the angle β is set to 30°.

Since the arrangement surface 58 is inclined with respect to the outer surface of the left side wall 66 of the female housing 36, an interval between a lower end part of the identifier 57 and the machine 59 is smaller than that between an upper end part of the identifier 57 and the machine 59. An interval in the lateral direction between the lower end part of the identifier 57 and the upper end part of the identifier 57 falls within a depth of field range of the machine 59. In this way, the entire identifier 57 can be focused in detecting the identifier 57 by the machine 59.

### Functions and Effects of Embodiment

Next, functions and effects of this embodiment are described. According to this embodiment, the female retainer 25 is movable between the retracted position where the restricting portion 62 is retracted from the resilient deformation space 43 and the locking position where the restricting portion 62 is located in the resilient deformation space 43 with the female terminals 37 locked by the female locking lances 42, and the female retainer 25 further moves between the locking position and the completion position indicating the completion of the connection of the female housing 36 and the male connector 12 as the male connector 12 and the female housing 36 are connected. By confirming that the female retainer 25 has moved from the locking position to the completion position, the completion of the connection of the male connector 12 and the female connector 11 can be confirmed. In this way, it becomes unnecessary to separately move a connection assurance member after the connecting operation of the male connector 12 and the female connector 11, wherefore the efficiency of an assembly operation of the female connector 11 can be improved.

The completion of the connection of the male connector 12 and the female connector 11 can be confirmed by confirming that the female retainer 25 is at least partially exposed through the detection window 61.

The completion of the connection of the male connector 12 and the female connector 11 can be confirmed by detecting the exposure of the identifier 57 through the detection window 61 by the machine 59.

Since the arrangement surface 58 is inclined with respect to the wall part of the female housing 36, a focal length between the machine 59 and the identifier 57 can be varied partially in the arrangement surface 58 in detecting the identifier 57 through the detection window 61 by the machine 59.

Since the ribs 29 make it impossible for the machine 59 to detect the identifier 57 through the viewing window 60, the identifier 57 is not detected by the machine 59 with the female retainer 25 moved to the locking position. In this way, it is suppressed that the identifier 57 is erroneously detected by the machine 59 in a state where the male connector 12 and the female connector 11 are not properly connected.

On the other hand, since the identifier 57 can be visually confirmed through the viewing window 60, the position of the identifier 57 can be grasped in advance. Therefore, the identifier 57 can be reliably found at the completion position.

It can be made impossible for the machine 59 to detect the identifier 57 through the viewing window 60 by a simple configuration of providing the ribs 29.

The female retainer 25 can be moved from the locking position to the completion position by connecting the male connector 12 and the female connector 11. In this way, it becomes unnecessary to separately move the connection assurance member after the connecting operation of the male connector 12 and the female connector 11, wherefore work efficiency can be improved.

The female retainer 25 can be moved from the completion position to the locking position by separating the male connector 12 and the female connector 11. In this way, it becomes unnecessary to move the female retainer 25 from the completion position to the locking position after the male connector 12 and the female connector 11 are separated.

### Other Embodiments

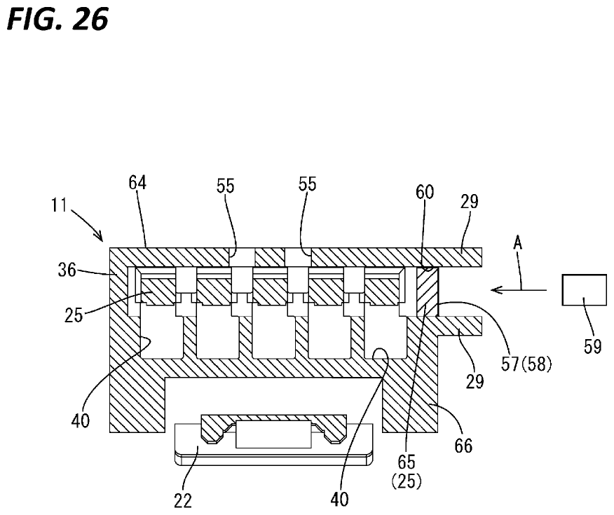

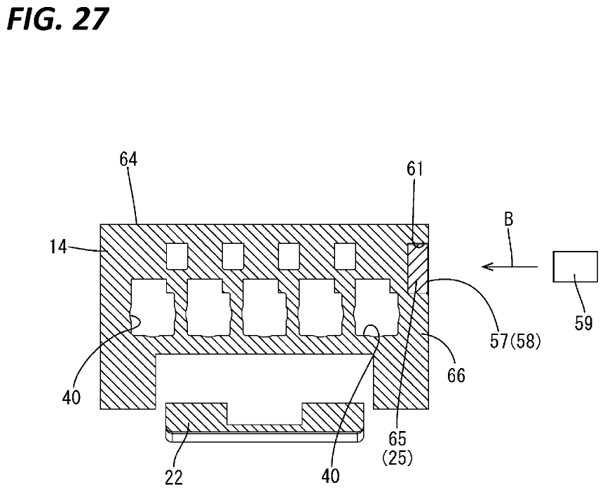

(1) Although the female connector 25 mounted in the female connector 11 is provided with the identifier 57, there is no limitation to this and the identifier 57 may be provided on the male retainer 15 mounted into the male connector 12. Further, the identifiers 57 may be provided on both the female retainer 25 and the male retainer 15.
(2) Although the male connector 12 includes the male retainer 15 having the contact portion 32, there is no limitation to this and the contact portion 32 may be provided in the male housing 14 and the male retainer 15 may be omitted.
(3) The detection window 61 may be omitted.
(4) The identifier 57 may be omitted.
(5) As shown in FIGS. 26 and 27, the arrangement surface 58 provided with the identifier 57 may be provided in parallel to the left side surface of the left side wall 66 of the female housing 36.
(6) The viewing window 60 may be omitted.
(7) The blocking portion is not limited to the ribs 29 and may be in the form of a circular column or an angular column such as a triangular column or a rectangular column. The blocking portion may be in the form of a cone or a pyramid such as a triangular pyramid or a rectangular pyramid and an arbitrary shape can be adopted.
(8) The locking portions 34 of the male retainer 15 mounted in the male connector 12 may be omitted. Further, the locking portions 34 may be provided in the male housing 14.
(9) The auto-focus adjustment function of the machine 59 may be omitted.

### LIST OF REFERENCE NUMERALS

10: connector assembly
11: female connector
12: male connector
13: male terminal
14: male housing
15: male retainer
16: tab
17: wire connecting portion
18: wire
19: receptacle
20: male cavity
21: male locking lance
22: lock arm
23 lock portion
24: lock receiving portion
25: female retainer
26: pressing projection
27: lock portion
28: recess
29: rib
30: resilient deformation space
31: restricting portion of male retainer
32: contact portion
33: arm portion of male retainer
34: locking portion
35: lock receiving portion
36: female housing
37: female terminal
38: connecting tube portion
39: wire connecting portion
40: female cavity
41: retainer accommodating portion
42: female locking lance
43: resilient deformation space
44: locking recess
45: first locking portion
46: second locking portion
47: arm portion of female retainer
48: third locking portion
49: first lock receiving portion
50: second lock receiving portion
51: slit
52: resilient deforming portion
53: projection
54: front third lock receiving portion
55: rear third lock receiving portion
56: escape recess
57: identifier
58: arrangement surface
59: machine
60: viewing window
61: detection window
62: restricting portion of female retainer
63: upper wall of female retainer
64: upper wall of female housing
65: left side wall of female retainer
66: left side wall of female housing

1. A connector to be connected to a mating connector, comprising
a terminal;
a housing for accommodating the terminal; and
a retainer to be movably assembled with the housing,
the housing including a resiliently deformable locking lance for locking the terminal,
the retainer including a restricting portion for restricting resilient deformation of the locking lance by entering a resilient deformation space, the locking lance being resiliently deformed into the resilient deformation space,
the retainer being movable between a retracted position where the restricting portion is retracted from the resilient deformation space and a locking position where the restricting portion is located in the resilient deformation space with the terminal locked by the locking lance, and
the retainer further moving between the locking position and a completion position indicating the completion of connection of the housing and the mating connector as the mating connector and the housing are connected.

2. The connector of claim 1, wherein a detection window for at least partially exposing the retainer is open at a position corresponding to the retainer at the completion position in the housing.

3. The connector of claim 2, wherein the retainer includes an identifier detectable by a predetermined machine on a part exposed through the detection window at the completion position.

4. The connector of claim 3, wherein:
the identifier is provided on an arrangement surface provided on the retainer, and
the arrangement surface is inclined with respect to a wall part formed with the detection window, out of the housing.

5. The connector of claim 3, wherein:
a viewing window for exposing the identifier is open at a position corresponding to the identifier with the retainer moved to the locking position in the housing, and
the housing is provided with a blocking portion for blocking detection of the identifier through the viewing window by the predetermined machine.

6. The connector of claim 5, wherein the blocking portion is a rib projecting outward from a hole edge part of the detection window.

7. A connector assembly, comprising:
the connector of claim 1; and
a mating connector to be connected to the connector.

8. The connector assembly of claim 7, wherein the mating connector includes a contact portion for moving the retainer from the locking position to the completion position by contacting the retainer from a connection direction to the connector when the mating connector is connected to the connector.

9. The connector assembly of claim 7, wherein:
the mating connector includes a locking portion projecting toward the connector and to be locked to the retainer,
the retainer is moved from the completion position to the locking position by locking the locking portion to the retainer in separating the mating connector and the connector, and
locking of the locking portion and the retainer is released when the retainer is moved to the locking position.
